(19) United States
(12) Patent Application Publication
(10) Pub. No.: US 2018/0276181 A1
(43) Pub. Date: Sep. 27, 2018

(54) BLENDING EVALUATION DEVICE AND BLENDING DEVICE

(71) Applicant: Panasonic Intellectual Property Management Co., Ltd., Osaka (JP)

(72) Inventors: ATUSI OOKUMO, Kanagawa (JP); KENTAROU IIDA, Kanagawa (JP); TAKASHI TAMURA, Kanagawa (JP); RYUJI SUGIZAKI, Tokyo (JP)

(21) Appl. No.: 15/919,868

(22) Filed: Mar. 13, 2018

(30) Foreign Application Priority Data
Mar. 24, 2017 (JP) 2017-059184

(51) Int. Cl. G06F 17/18

(52) U.S. Cl. CPC G06F 17/18

(57) ABSTRACT

A blending evaluation device includes: a communication interface that receives evaluations of a blended beverage in which a plurality of beverage raw materials are blended, each of the evaluations being made by a user who drank the blended beverage; a memory that stores the evaluations, each evaluation being associated with environmental information related to an environment in which the user drank the blended beverage; and a controller that performs statistical analysis of information on the evaluations, wherein the communication interface receives a condition that specifies the environmental information; the controller retrieves, from the memory, at least one evaluation associated with the environmental information specified by the condition, and performs statistical analysis of the retrieved at least one evaluation, and the communication interface transmits a result of the statistical analysis.

### BACKGROUND

### 1. Technical Field

The present disclosure relates to a blending evaluation device and a blending device and, more particularly, to a beverage blending evaluation device and a beverage blending device.

### 2. Description of the Related Art

Along with diversified tastes of users, devices that bend beverages and the like are being widely used in recent years. In response to this, Japanese Unexamined Patent Application Publication No. 2010-70250, for example, discloses a beverage filling system that controls a beverage supplier according to beverage information written to an identification tag so as to pour a predetermined beverage into each of a plurality of containers.

### SUMMARY

With the beverage filling system disclosed in Japanese Unexamined Patent Application Publication No. 2010-70250, however, the user is asked to blend beverages and the like, preventing them from being appropriately blended with ease.

One non-limiting and exemplary embodiment provides a blending device and a blending evaluation device that can evaluate whether blending by the user is appropriate.

In one general aspect, the techniques disclosed here feature a blending evaluation device includes: a communication interface that receives evaluations of a blended beverage in which a plurality of beverage raw materials are blended, each of the evaluations being made by a user who drank the blended beverage; a memory that stores the evaluations, each evaluation being associated with environmental information related to an environment in which the user drank the blended beverage; and a controller that performs statistical analysis of information on the evaluations, wherein the communication interface receives a condition that specifies the environmental information; the controller retrieves, from the memory, at least one evaluation associated with the environmental information specified by the condition, and performs statistical analysis of the retrieved at least one evaluation, and the communication interface transmits a result of the statistical analysis.

According to an aspect of the present disclosure, whether blending by the user is appropriate can be evaluated according to a result resulting from statistically analyzing a subjective evaluation by another user who used the blending.

It should be noted that these comprehensive or specific aspects may be implemented as a system, a method, an integrated circuit, a computer program, a computer-readable non-transitory recording medium such as a computer-readable compact disc-read-only memory (CD-ROM), or any selective combination of a system, a device, a method, an integrated circuit, a computer program, and a recording medium.

Additional benefits and advantages in an aspect of the present disclosure will become apparent from the specification and drawings. The benefits and/or advantages may be individually obtained by some embodiments and features described in the specification and drawings, which need not all be provided in order to obtain one or more of such benefits and/or advantages.

### BRIEF DESCRIPTION OF THE DRAWINGS

FIG. 1 is a block diagram illustrating an example of the structure of a system according to an embodiment of the present disclosure;

FIG. 2 illustrates an example of personal attribute information in the embodiment of the present disclosure;

FIG. 3 illustrates an example of environmental information in the embodiment of the present disclosure;

FIG. 4 illustrates an example of a recipe evaluation screen in the embodiment of the present disclosure;

FIG. 5 illustrates an example of a database, including evaluation information, in the embodiment of the present disclosure;

FIG. 6 illustrates an example of an analysis result display screen in the embodiment of the present disclosure;

FIG. 7 illustrates a post-filtering analysis result display screen in the embodiment of the present disclosure;

FIG. 8 is a sequence diagram illustrating an example of an operational flow in the embodiment of the present disclosure;

FIG. 9 illustrates an example of a recipe evaluation screen in a first variation of the embodiment of the present disclosure;

FIG. 10 illustrates an example of a database, including evaluation information, in the first variation of the embodiment of the present disclosure;

FIG. 11 illustrates an example of an analysis result display screen in the first variation of the embodiment of the present disclosure;

FIG. 12 illustrates a post-filtering analysis result display screen in the first variation of the embodiment of the present disclosure;

FIG. 13 illustrates an example of a display screen for recipe adjustment in a second variation of the embodiment of the present disclosure; and

FIG. 14 illustrates an example of a similar recipe display screen in the second variation of the embodiment of the present disclosure.

### DETAILED DESCRIPTION

An embodiment of the present disclosure will be described in detail with reference to the drawings. The embodiment described below is just an example. The present disclosure is not limited by the embodiment.

### Embodiment

### System Structure

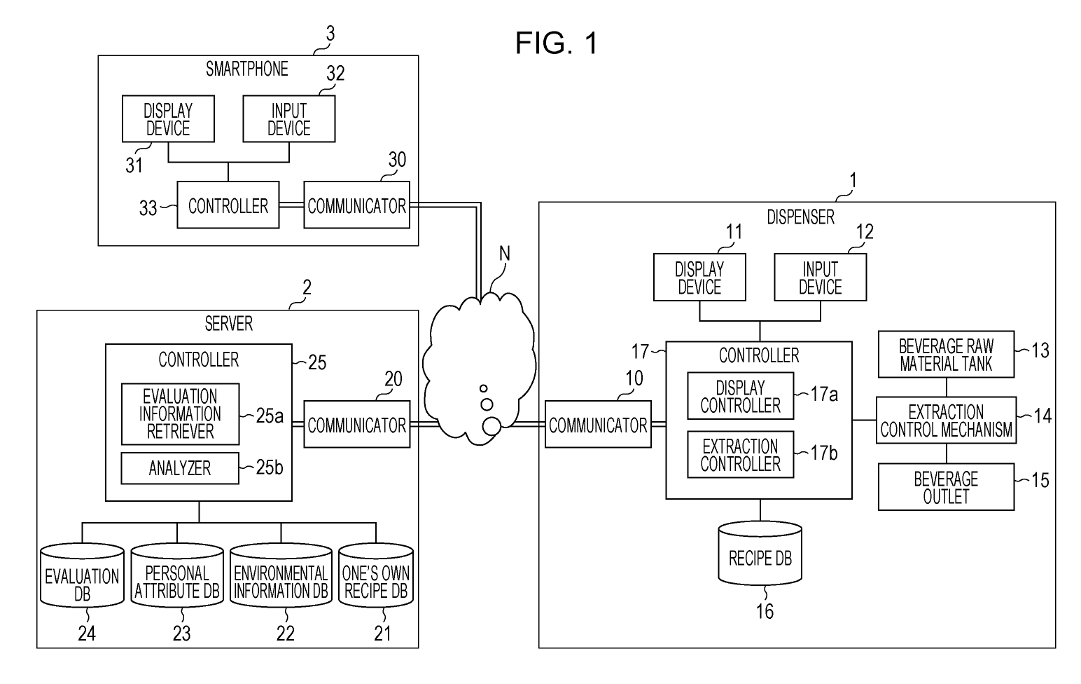

FIG. 1 is a block diagram illustrating an example of the structure of a system according to this embodiment. The system illustrated in FIG. 1 has a structure in which a dispenser 1, a server 2, and a smartphone 3 are interconnected through a network N.

The dispenser 1 is placed in, for example, a restaurant. The dispenser 1 is an apparatus that receives a manipulation by a user in the restaurant and provides a beverage in response to the manipulation and information about the beverage. The dispenser 1 also provides a blended beverage in which a plurality of beverages are blended.

The server 2 is an apparatus that receives information that the dispenser 1 and/or smartphone 3 has accepted from a user and transmits information to be provided to the dispenser 1 and/or smartphone 3.

The smartphone 3 is owned by a user who made a registration so that the user is allowed to use a beverage evaluation service provided by the system including the dispenser 1 and server 2. The user transmits information to and receives information from the server 2 and/or dispenser 1 through the smartphone 3.

The network N may be a wireless network or may be a wired network. In addition, a plurality of dispensers 1, a plurality of servers 2, and a plurality of smartphone 3 may be connected to the network N.

The dispenser 1 has a communicator 10, a display device 11, an input device 12, a beverage raw material tank 13, an extraction control mechanism 14, a beverage outlet 15, a recipe database (DB) 16, and a controller 17.

The communicator 10 is an interface that communicates with the server 2 and/or smartphone 3 through the network N.

The display device 11 is, for example, a liquid crystal display (LCD). The display device 11 displays, for example, information output from the controller 17.

The input device 12 is, for example, a touch panel attached to the front surface of the display device 11. The input device 12 accepts a manipulation by a user and outputs information about the accepted manipulation to the controller 17.

The beverage raw material tank 13 includes tanks in each of which one of water, carbonated water, various types of syrups, and the like is stored.

The extraction control mechanism 14 controls an amount by which a beverage in the beverage raw material tank 13 is to be extracted, under control of the controller 17. The extraction control mechanism 14 includes, for example, nozzles, valves, and pumps.

The beverage outlet 15 is a space in which a cup, a glass, or any other empty vessel is placed. When, for example, the user manipulates the input device 12, a beverage is poured from the beverage raw material tank 13 through the extraction control mechanism 14 into the cup placed in the beverage outlet 15.

The recipe database DB 16 stores recipes for various beverage raw materials. In a recipe for beverage raw materials of a carbonated orange beverage, for example, a blending ratio between an orange syrup and carbonated water is stored (the blending ratio is a reference blending ratio). When the dispenser 1 extracts a blended beverage created by blending various beverage raw materials or at least one of a plurality of beverage raw materials, the recipe database DB 16 is referenced by the controller 17.

The controller 17 controls individual sections in the dispenser 1. The controller 17 has a display controller 17a and an extraction controller 17b.

The display controller 17a creates information to be displayed on the display device 11 and causes the display device 11 to display the information. For example, the display controller 17a receives information transmitted from the server 2 through the communicator 10, and causes the display device 11 to display the received information. Furthermore, the display controller 17a receives information about a manipulation accepted by the input device 12, and performs display control according to the information about the manipulation.

The display controller 17a also creates information to be transmitted to the server 2, according to the information about the manipulation by the user, after which the display controller 17a transmits the created information to the server 2 through the communicator 10.

The extraction controller 17b receives, through the input device 12, a command to extract a beverage, controls the extraction control mechanism 14 with reference to the recipe database DB 16 and the blending ratio of the blended beverage to be extracted, and extracts the blended beverage.

The server 2 has a communicator 20, a one's own recipe DB 21, an environmental information DB 22, a personal attribute DB 23, an evaluation DB 24, and a controller 25.

The communicator 20 is an interface that communicates with the dispenser 1 through the network N.

The one's own recipe DB 21 stores identifiers (IDs), each of which identifies a user, and user-created recipes in correspondence to each other. A recipe created by a user includes, for example, the beverage raw materials of the blended beverage that the user extracted and the blending ratio of the beverage raw materials.

The environmental information DB 22 stores outside temperature in an area in which a restaurant or the like in which the dispenser 1 is placed is present, meteorological information about a weather and the like, and time information in correspondence to one another. In the environmental information DB 22, time information and temperature in a store or the like in which the dispenser 1 is placed may be stored in correspondence to each other.

The personal attribute DB 23 stores the IDs of users and information that the users registered to use the beverage evaluation service in advance in correspondence to each other. Information that a user registered includes, for example, the mail address of the user and personal attribute information including preference information. Personal attribute information includes, for example, the sex, date of birth, residence, and hometown of the user. Preference information includes, for example, favorite meals (meal preferences), favorite beverages (beverage preferences), smoking (smoking preferences).

The evaluation DB 24 stores evaluation information about evaluations that users determined, in correspondence to information stored in the one's own recipe DB 21, environmental information DB 22, and personal attribute DB 23.

The controller 25 controls individual sections in the server 2. The controller 25 has an evaluation information retriever 25a and an analyzer 25b.

The evaluation information retriever 25a retrieves, from evaluation information stored in the evaluation DB 24, evaluation information satisfying conditions received from the user through the smartphone 3. The evaluation information retriever 25a then outputs the retrieved evaluation information to the analyzer 25b.

The analyzer 25b analyzes the evaluation information received from the evaluation information retriever 25a and outputs an analysis result to, for example, the smartphone 3 of the user.

The smartphone 3 has a communicator 30, a display device 31, an input device 32, and controller 33.

The communicator 30 is an interface that communicates with the server 2 and/or dispenser 1 through the network N.

The display device 31 is, for example, an LCD. The display device 31 displays, for example, information output from the controller 33.

The input device 32 is, for example, a touch panel attached to the front surface of the display device 31. The input device 32 accepts a manipulation by the user and outputs information about the accepted manipulation to the controller 33.

The controller 33 controls, for example, communication with the server 2 and/or dispenser 1 and also controls displaying on the display device 31. For example, the controller 33 creates information to be displayed on the display device 31, according to information received from the server 2, after which the controller 33 outputs the created information to the display device 31. The controller 33 also creates information to be transmitted to the server 2, according to manipulation information received from the input device 32, after which the controller 33 transmits the created information to the server 2 through the communicator 30.

### Example of Personal Attribute Information to be Registered

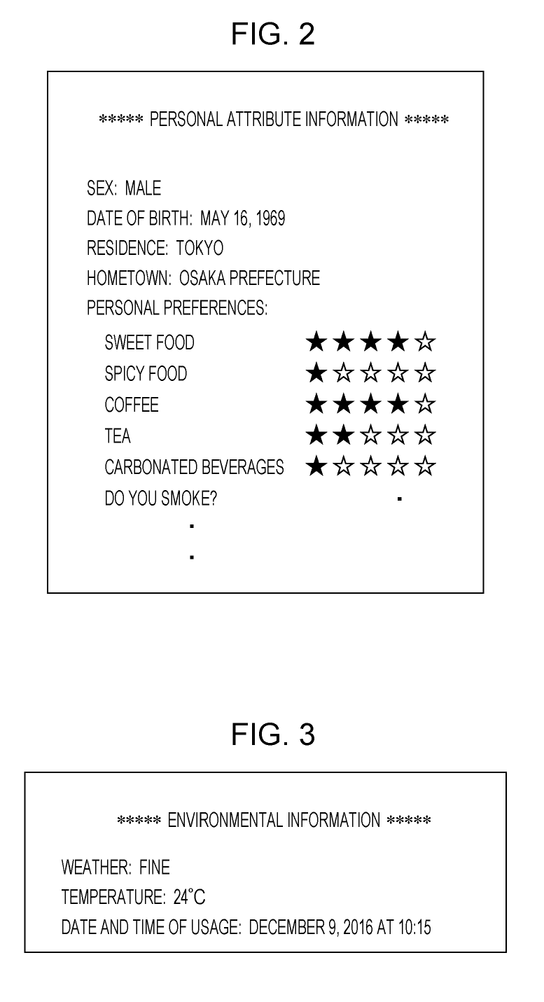

FIG. 2 illustrates an example of personal attribute information in this embodiment. In FIG. 2, the sex, date of birth, residence, and hometown of a user as well as information about preferences of the user are illustrated as personal attribute information. When making a registration to use the beverage evaluation service, the user registers various types of information illustrated in FIG. 2 through, for example, the smartphone 3. The registered information is transmitted from the smartphone 3 to the server 2 and is then stored in the personal attribute DB 23. Example of environmental information stored in the environmental DB

FIG. 3 illustrates an example of environmental information in this embodiment. In FIG. 3, a weather, temperature, and a date and time of usage are indicated as environmental information. In the environmental information, an environment in which the user drank a blended beverage by using the beverage evaluation service, that is, a weather and temperature in an area in which the restraint or the like in which the user drank the blended beverage is present, is made to correspond to the date and time of usage. Environmental information may include, for example, the psychological state of the user, such as delight, anger, sorrow, or pleasure emotion. A learning function, for example, may be used to detect the psychological state according to image data captured by a camera or inputs from a sensor such as an infrared sensor.

### Example of a Method of Creating a Recipe to be Stored in the One's Own Recipe DB

Next, an example of a method by which the user creates a recipe will be described. For convenience of explanation, a user who creates a recipe will be referred to as the user A and the recipe that the user A created will be referred to as the recipe of the user A.

For example, the user A creates a recipe on the dispenser 1. Specifically, on the input device 12 of the dispenser 1, the user A performs a manipulation to indicate the use of the beverage evaluation service, after which the user A enters the ID of the user A and performs a manipulation to indicate creation of a recipe.

Upon the receipt of information about the manipulation from the user A, the display controller 17a in the dispenser 1 causes the display device 11 to display a selection screen on which beverage raw materials are selected and a manipulation screen on which a blending ratio is entered.

The user A selects a beverage to be combined from the selection screen and enters a blending ratio of the beverage on the manipulation screen. When the user A performs a manipulation to register the selected beverage raw material and entered blending ratio as a recipe of the user A, the display controller 17a transmits recipe information including the recipe of the user A and the ID of the user A to the server 2. When the user A performs a manipulation to extract a blended beverage obtained by combining the selected beverage raw material according to the entered blending ratio, the extraction controller 17b extracts the blended beverage.

The one's own recipe DB 21 in the server 2 stores the recipe, received from the dispenser 1, of the user A and the ID of the user A in correspondence to each other. Each recipe is assigned an ID (recipe ID) that identifies the recipe.

The user A may create a recipe by using the smartphone 3 that the user A owns, instead of using the dispenser 1.

### Example of a Method of Using a Recipe

Next, an example of a method of a recipe stored in the one's own recipe DB 21 and evaluating the recipe. For convenience of explanation, a user who drank a blended beverage extracted on the basis of a recipe and evaluates the beverage will be referred to as the user B. The user B may be the user A described above, that is, the user who created the recipe.

For example, the user B uses a recipe on the dispenser 1. Specifically, the user B performs a manipulation to indicate the use of the beverage evaluation service on the input device 12 of the dispenser 1, after which the user B enters the ID of the user B and performs a manipulation to indicate the use of the recipe.

Upon the receipt of information about the manipulation from the user B, the display controller 17a in the dispenser 1 transmits a request for a recipe to the server 2. Upon the receipt of the request for a recipe from the dispenser 1, the server 2 reads out a recipe from the one's own recipe DB 21 and transmits information about the read-out recipe to the dispenser 1.

The server 2 may read out a recipe that was often used in the past, may read out a recipe that was highly evaluated, which will be described later, or may be read out a recipe suiting a preference of the user B. If, for example, the user B prefers carbonated beverages, the server 2 may read out a recipe including many carbonated beverages.

The display controller 17a in the dispenser 1 receives the recipe information from the server 2 and displays the received recipe information on the display device 11. The recipe information to be displayed includes, for example, the ID of the recipe, beverage raw materials on the recipe, and the blending ratio of the beverage raw materials.

The user B performs a manipulation to select a recipe that the user B wants to retrieve with reference to the recipe information displayed on the display device 11. The extraction controller 17b receives information about the manipulation by the user B, and extracts a blended beverage according to the recipe selected by the user B. The display controller 17a also receives the information about the manipulation by the user B, and transmits, to the server 2, actual extraction information that includes the ID of the user B, the ID of the receipt selected by the user B, a date and time of usage, and the ID of the dispenser 1 used.

Upon the receipt of the actual extraction information from the dispenser 1, the server 2 reads out the mail address of the user B from the personal attribute DB 23 with reference to the ID of the user B, and transmits, to the user B, mail that asks the user B to evaluate the recipe that the user B selected and enter an evaluation result. The mail asking for an entry of an evaluation result includes the uniform resource locator (URL) of a webpage on which a recipe evaluation input screen is displayed.

On the smartphone 3, the user B receives the mail that asks the user B to enter an evaluation result for the recipe that the user B selected. The user B moves to the webpage indicated by the URL included in the received mail and evaluates the recipe that the user B selected.

### Example of a Recipe Evaluation Screen

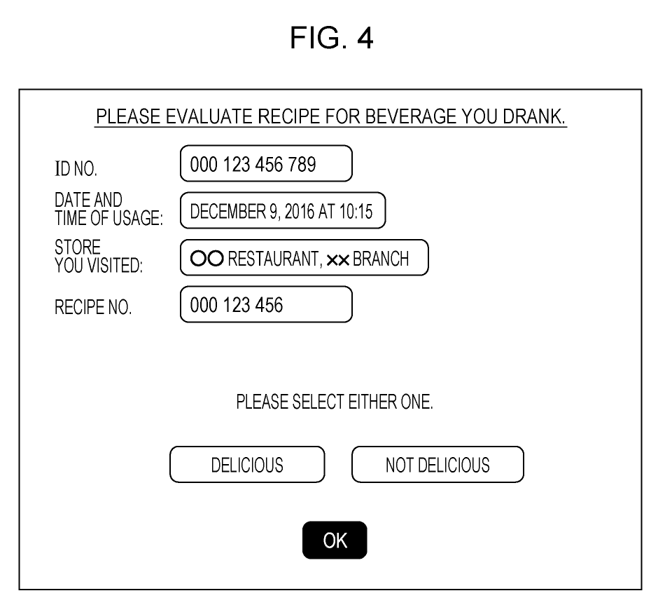

FIG. 4 illustrates an example of a recipe evaluation screen in this embodiment. The recipe evaluation screen in FIG. 4 is displayed on the display device 31 of the smartphone 3 owned by the user B. The recipe evaluation screen in FIG. 4 displays text information asking for an evaluation, the ID of the user (in the example above, the ID of the user B), the ID of the recipe to be evaluated, a date and time at which the recipe was used, a store used, and evaluation buttons to enter an evaluation result. The evaluation buttons in the example in FIG. 4 are DELICIOUS and NOT DELICIOUS, either of which is selected for the blended beverage extracted according to the recipe used.

To make one's own subjective evaluation, the user B drinks the blended beverage extracted according to the recipe used, decides whether the blended beverage is delicious or not delicious, and presses either of the DELICIOUS and NOT DELICIOUS buttons on the recipe evaluation screen in FIG. 4 accordingly. The user B then presses the OK button. When the controller 33 in the smartphone 3 receives information about the manipulation by the user B, the controller 33 transmits, to the server 2, evaluation information including the ID of the user B, the ID of the evaluated recipe, a result of evaluation made by the user B.

The server 2 receives the evaluation information from the smartphone 3 of the user B, and stores the information in the evaluation DB 24.

### Example of a Database

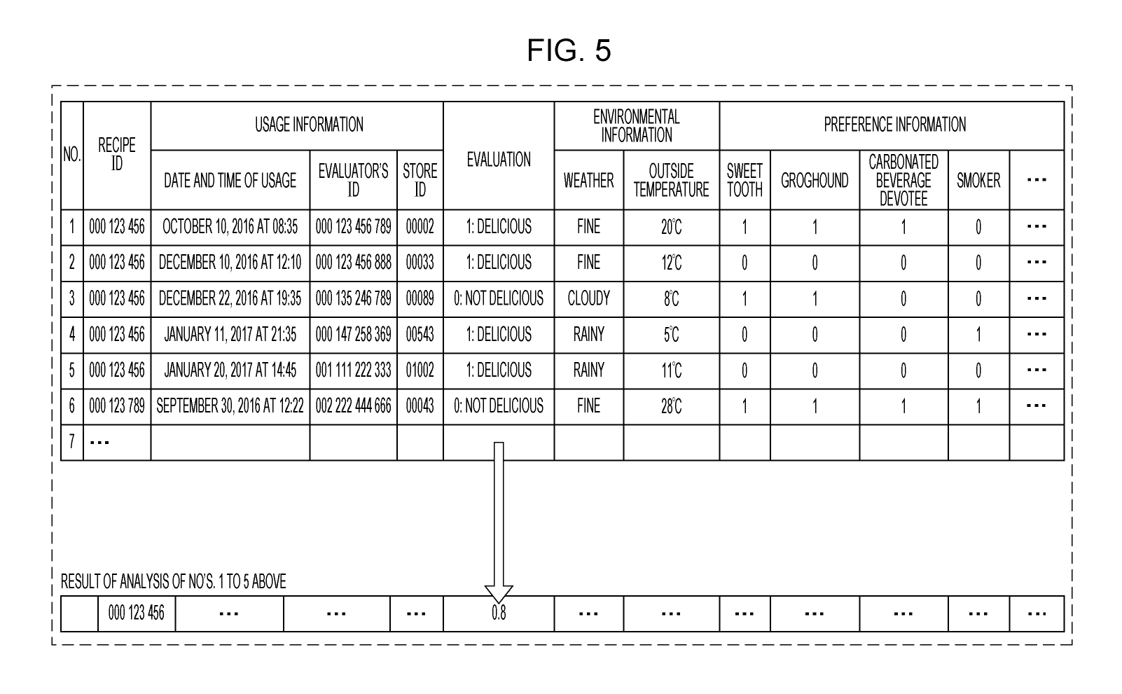

FIG. 5 illustrates an example of a database in this embodiment. The database in FIG. 5 indicates information stored in the evaluation DB 24 in the server 2 in tabular form.

On each numbered row in FIG. 5, the recipe ID of an evaluated recipe, usage information, an evaluation, environmental information, and preference information are made to correspond to one another.

The controller 25 in the server 2 creates an integrative analysis result from a database as illustrated in FIG. 5.

As an example, FIG. 5 illustrates an integrative analysis result for Nos. 1 to 5, which is evaluation information for a recipe ID of 000123456. The evaluation information retriever 25a in the server 2 retrieves, for example, evaluation information items for the same recipe ID. The analyzer 25b combines the retrieved evaluation information items to create one analysis result, and outputs it to, for example, the smartphone 3 of the user.

The integrative analysis result for Nos. 1 to 5 in FIG. 5 is the average of the sum of a value of 1 indicating “delicious” and a value of 0 indicating “not delicious” at Nos. 1 to 5. However, this is not a limitation on the present disclosure. For example, the analyzer 25b may compare the average with a threshold, and if the average is equal to or higher than the threshold, may create an integrative analysis result indicating “delicious”. If the average is lower than the threshold, the analyzer 25b may create an integrative analysis result indicating “not delicious”. Alternatively, to create an analysis result, the analyzer 25b may calculate a weighted average according to information (environmental information, for example) associated with evaluation information items. As another method of creating an analysis result, the analyzer 25b may determine a representative value according to information (environmental information, for example) that is included in retrieved evaluation information and is associated with evaluation information items.

### Example of an Analysis Result Display Screen

After creating a recipe, the user A confirms an evaluation made by another user (for example, the user B described above) for the recipe.

For example, the user A moves to the webpage for the beverage evaluation service on the smartphone 3. When the user A performs a manipulation to request an analysis result for evaluation information about the recipe that the user A created (that is, the recipe of the user A), analysis information request including the recipe ID of the recipe to be analyzed is transmitted to the server 2.

When the evaluation information retriever 25a in the server 2 receives the analysis information request, the evaluation information retriever 25a retrieves evaluation information, in the database illustrated in FIG. 5, corresponding to the recipe ID included in the analysis information request, after which the evaluation information retriever 25a outputs the retrieved evaluation information to the analyzer 25b. The analyzer 25b analyzes the retrieved evaluation information and creates an analysis result. The server 2 transmits the created analysis information to the smartphone 3 of the user A. The controller 33 in the smartphone 3 receives the analysis information and causes the display device 31 to display the received analysis information.

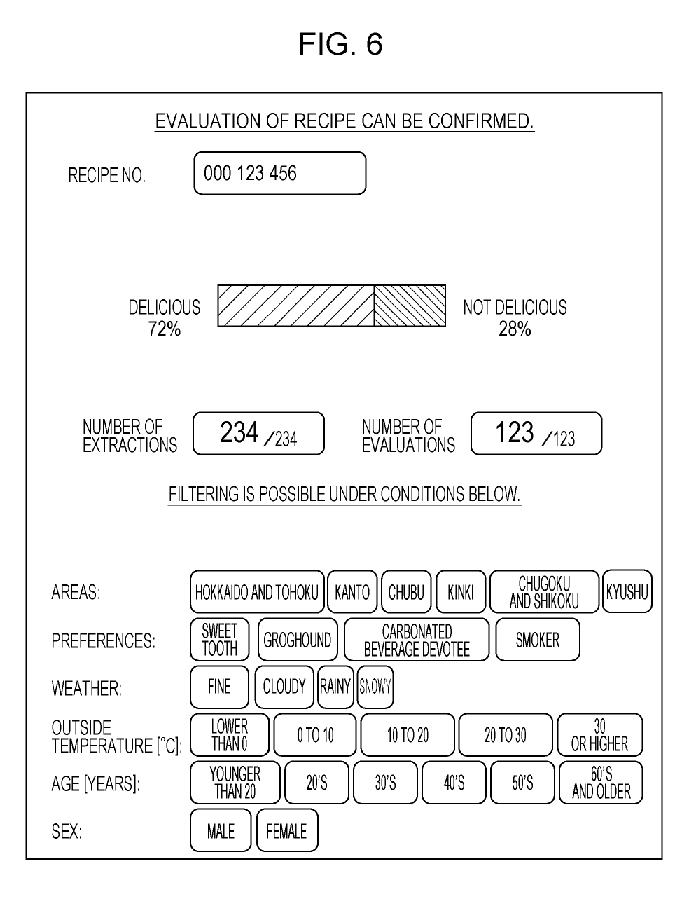

FIG. 6 illustrates an example of an analysis result display screen in this embodiment. The display screen in FIG. 6 displays a recipe ID, an analysis result for evaluation information, the number of extractions of a blended beverage based on the recipe indicated by the recipe ID, the number of evaluations of the blended beverage, selection buttons for filtering conditions under which evaluation information is narrowed down. The analysis result indicates a ratio between an evaluation indicating “delicious” and an evaluation indicating “not delicious”. The filtering conditions narrow down environmental information, and personal attribute information including preference information, which are made to correspond to one another in the evaluation DB 24.

When the user A presses any of the selection buttons for the filtering conditions, the filtering condition corresponding to the pressed selection button is transmitted from the smartphone 3 to the server 2. When the evaluation information retriever 25a in the server 2 receives the filtering condition, the evaluation information retriever 25a retrieves evaluation information satisfying the filtering condition from the evaluation information about the recipe ID for which analysis is in progress. The analyzer 25b then analyses the retrieved evaluation information and creates an analysis result. The server 2 transmits the created analysis result to the smartphone 3 of the user A. The controller 33 in the smartphone 3 receives the analysis result and causes the display device 31 to display the received analysis result.

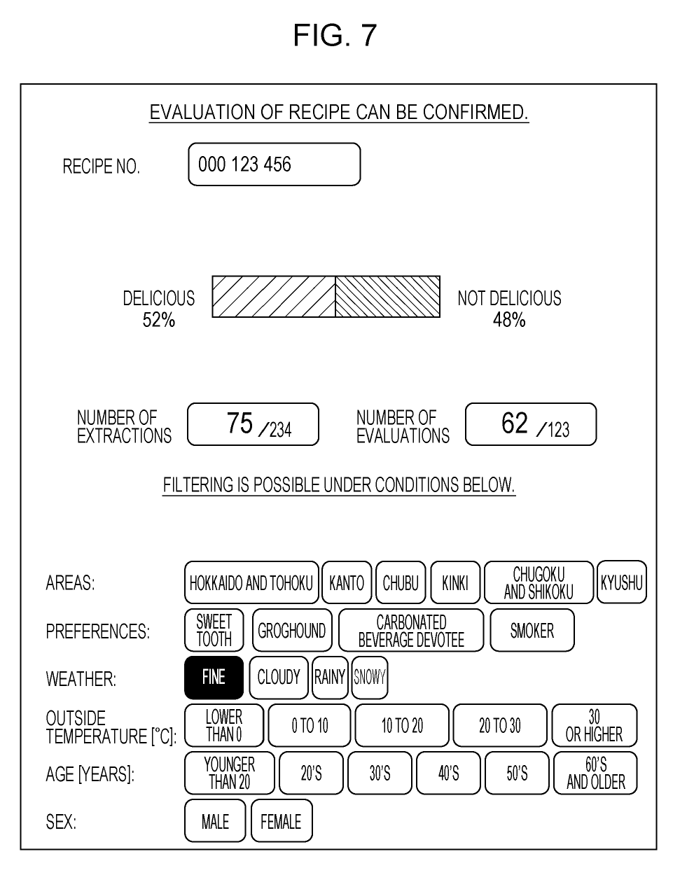

FIG. 7 illustrates a post-filtering analysis result display screen in the embodiment. On the display screen in FIG. 7, as an example, the user A selected the filtering condition that the weather is fine on the display screen in FIG. 6.

When the evaluation information retriever 25a in the server 2 receives the filtering condition that the weather is fine, the evaluation information retriever 25a performs an operation to retrieve evaluation information at Nos. 1 and 2 in Evaluation information about the recipe ID of 000123456 indicated in FIG. 5 at Nos. 1 to 5. The analyzer 25b then analyzes evaluation information at Nos. 1 and 2 and creates an analysis result.

As described above, when a user selects a condition, a variety of analysis results can be obtained.

### Operational Sequence

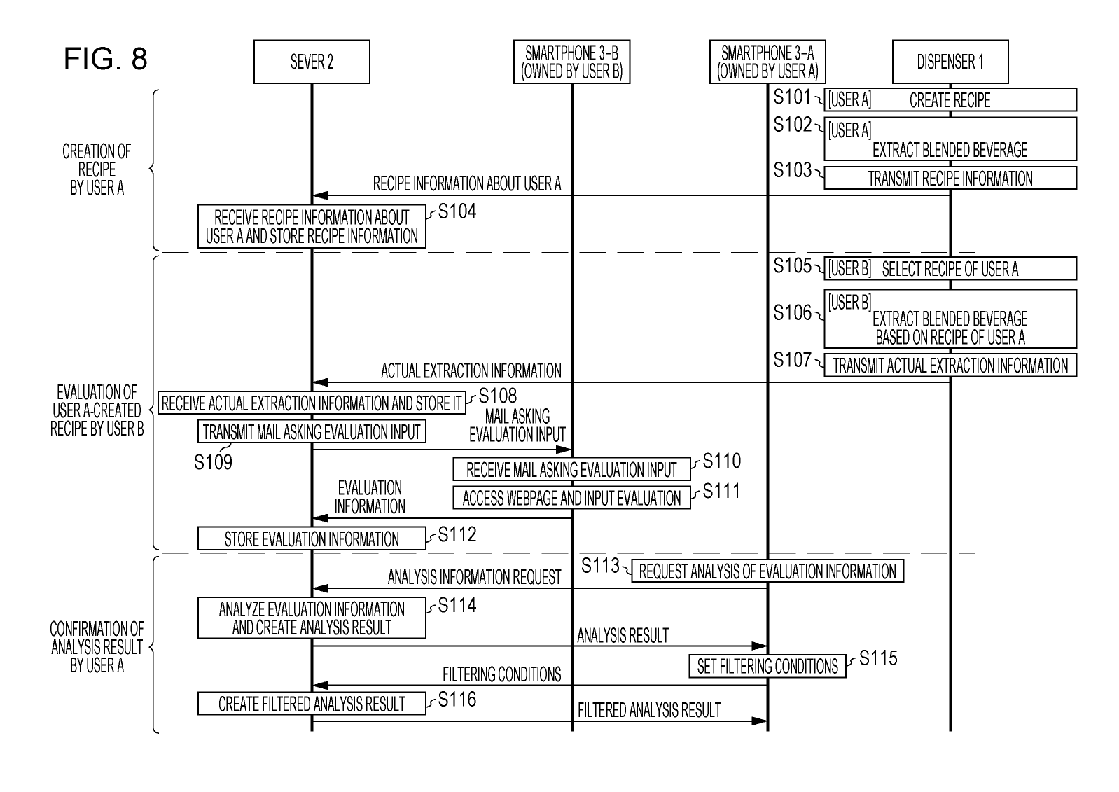

FIG. 8 is a sequence diagram illustrating an example of an operational flow in this embodiment. Operations in the sequence illustrated in FIG. 8 include operations by which the user A creates a recipe on the dispenser 1, operations by which the user B evaluates the recipe of the user A, and operations by which the user A confirms the analysis result of the recipe that the user A created (that is, the recipe of the user A). First, operations by which the user A creates a recipe will be described.

In step 101 (S101), the user A creates a recipe on the dispenser 1.

In S102, the dispenser 1 extracts a blended beverage based on the recipe created by the user A, in response to the manipulation by the user A.

In S103, the dispenser 1 transmits information about the recipe of the user A to the server 2.

In S104, the server 2 receives the information about the recipe of the user A and stores the received information in the one's own recipe DB 21.

This completes the operations by which the user A creates a recipe. Next, operations by which the user B evaluates the recipe of the user A will be described.

In S105, the user B selects the recipe of the user A on the dispenser 1.

In S106, the dispenser 1 extracts a blended beverage based on the recipe of the user A, in response to the manipulation by the user B.

In S107, the dispenser 1 transmits actual extraction information to the server 2.

In S108, the server 2 receives the actual extraction information from the dispenser 1 and stores the received actual extraction information in the in the evaluation DB 24.

In S109, the server 2 reads out the mail address of the user B from the personal attribute DB 23 with reference to the actual extraction information, and transmits mail asking an entry of an evaluation result to the user B.

In S110, the user B receives the mail asking an entry of an evaluation result with a smartphone 3-B owned by the user B.

In S111, on the smartphone 3-B, the user B moves to (accesses) the webpage indicated by the URL included in the mail and enters an evaluation result for the recipe of the user A.

In S112, the server 2 receives evaluation information including an evaluation made by the user B for the recipe of the user A, and stores the received evaluation information in the evaluation DB 24.

This completes the operations by which the user B evaluates the recipe of the user A. Although, in the example in FIG. 8, the user B evaluates the recipe of the user A, the recipe is evaluated by a plurality of other users. Next, operations by which the user A confirms the analysis result of the recipe of the user A.

In S113, the user A requests the server 2 to analyze the evaluation information about the created recipe (recipe of the user A) with a smartphone 3-A owned by the user A.

In S114, the server 2 receives an analysis information request, analyzes the evaluation information about the recipe of the user A, and creates an analysis result. The server 2 then transmits the created analysis result to the smartphone 3-A. The user A confirms the analysis result with the smartphone 3-A.

In S115, the user A sets filtering conditions under which the evaluation information is narrowed down with the smartphone 3-A owned by the user A.

In S116, the server 2 receives the filtering conditions, retrieves evaluation information satisfying the filtering conditions from the evaluation information about the recipe ID for which analysis is in progress, analyzes the retrieved evaluation information, and creates a filtered analysis result. The server 2 then transmits the filtered analysis result to the smartphone 3-A. The user A confirms the filtered analysis result with the smartphone 3-A.

According to the sequence described above, a user selects a favorite beverage raw material and stores, in the server 2, a recipe in which a blending ratio of the selected beverage raw material has been adjusted, after which evaluations made by other users for the recipe are analyzed under various conditions, enabling the user to confirm an analysis result.

Although, in the example in FIG. 8, the user A sets filtering conditions only once, the user A may set filtering conditions a plurality of times. Although, in the example in FIG. 8, the user A confirms the analysis result for the recipe of the user A, a user other than the user A may confirm the analysis result for the recipe of the user A.

### Effects

As described above, according to this embodiment, the server 2 receives a subjective evaluation of a recipe created by a user, the evaluation being made by another user who used the recipe, and provides a result resulting from statistical analysis to, for example, the user who created the recipe, so whether blending by the user is appropriate can be evaluated according to a result resulting from statistical analysis of the subjective evaluation by the other user who used the blending.

According to this embodiment, the server 2 can store a subjective evaluation in correspondence to various information items and can provide an analysis result obtained after filtering is performed by using the various information items, in response to a command from the user. Therefore, it is possible to evaluate, from many viewpoints, whether blending by the user is appropriate.

Although, in the embodiment described, an evaluation has been made between only two alternatives, “delicious” and “not delicious” as illustrated in FIG. 4, this is not a limitation on the present disclosure. An example in which different evaluation items are used will be described below as a first variation of this embodiment.

### First Embodiment of the Embodiment

### Variation of the Recipe Evaluation Screen

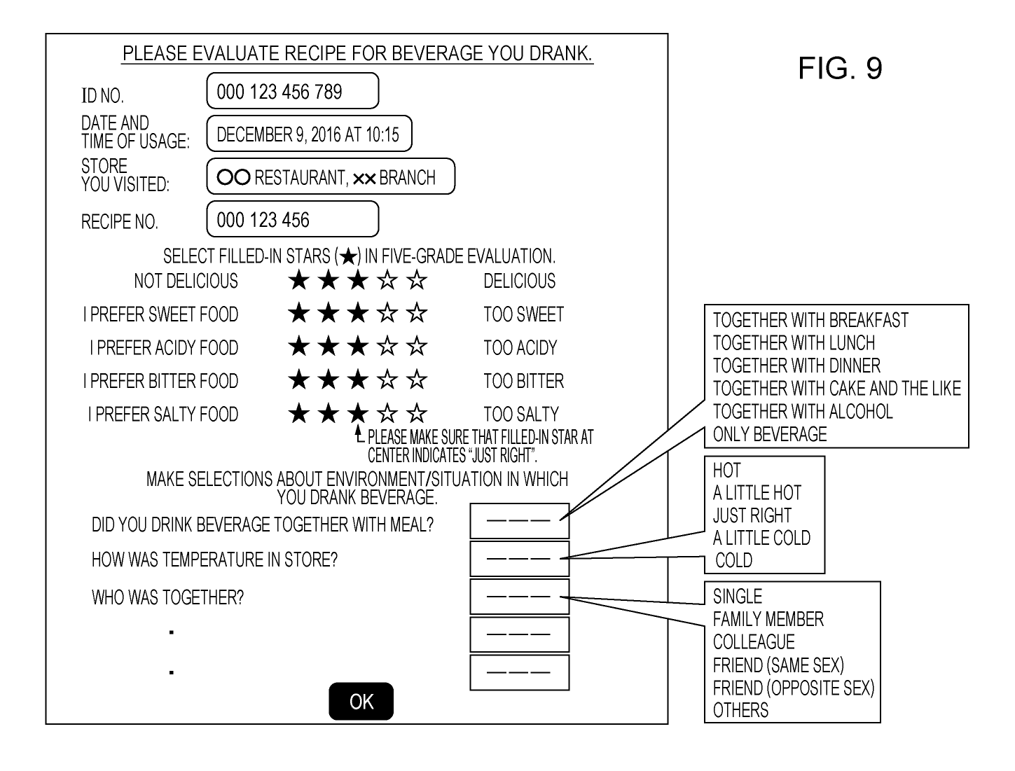

FIG. 9 illustrates an example of a recipe evaluation screen in a first variation of the embodiment. The recipe evaluation screen in FIG. 9 displays text information asking for an evaluation, the ID of the user, the ID of the recipe to be evaluated, a date and time at which the recipe was used, a store used, items to be evaluated, and an environment during usage.

The evaluation input items in FIG. 9 are deliciousness, sweet taste, acid taste, bitter taste, and salty taste, each of which is evaluated in five grades.

With the environment input items in FIG. 9, an answer can be selected from a plurality of alternatives for a question about an environment or situation at the time of the use of the recipe to be evaluated. For the question “did you drink beverage together with meal?” in FIG. 9, for example, an answer can be selected from “together with breakfast”, “together with lunch”, “together with dinner”, “together with cake and the like”, “together with alcohol”, and “only beverage”.

The user replies to the items on the evaluation screen in FIG. 9. The controller 33 in the smartphone 3 accepts information about a manipulation made by the user through the input device 32, and transmits, to the server 2, evaluation information including the ID of the user who has replied, the ID of an evaluated recipe, and information entered by the user.

The server 2 stores the evaluation information received from the smartphone 3 of the user B in the evaluation DB 24.

### Variation of a Database

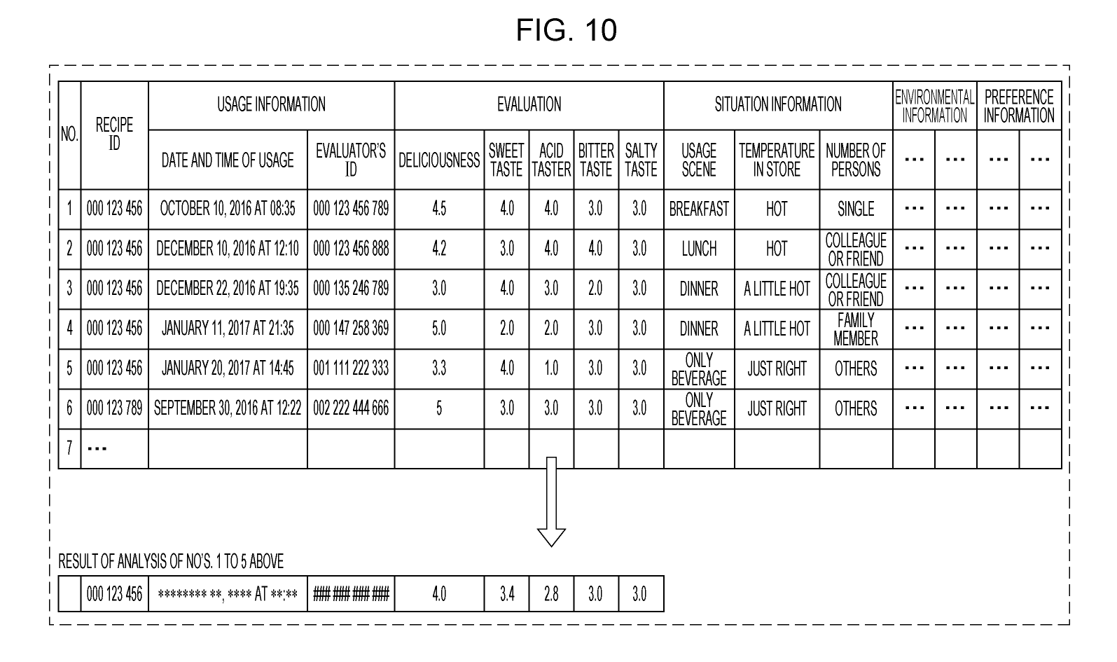

FIG. 10 illustrates an example of a database in the first variation of the embodiment. The database in FIG. 10 indicates information stored in the evaluation DB 24 in tabular form.

The evaluation items in the database in FIG. 10 differ from the evaluation items in the database in FIG. 5. Situation information, which is not included in the database in FIG. 5, is added to the database in FIG. 10. The situation information is information entered by the user for the environment input items in FIG. 9.

The server 2 creates an integrative analysis result from a database as illustrated in FIG. 10.

As an example, FIG. 10 illustrates an integrative analysis result for Nos. 1 to 5, at each of which an evaluation result is made for a recipe ID of 000123456. The server 2 combines evaluations for the same recipe ID in this way to create one analysis result, and outputs it to, for example, the smartphone 3 of the user.

The integrative analysis result for Nos. 1 to 5 in FIG. 10 is the average of values indicating evaluations of deliciousness, sweet taste, acid taste, bitter taste, and salty taste at Nos. 1 to 5. However, this is not a limitation on the present disclosure. For example, the analyzer 25b may compare the average for sweet taste with a threshold, and if the average is equal to or higher than the threshold, may create an integrative analysis result indicating “too sweet”. If the average is lower than the threshold, the analyzer 25b may create an integrative analysis result indicating “insufficient in sweat taste”. Alternatively, to create an analysis result, the analyzer 25b may calculate a weighted average according to information (environmental information, for example) associated with evaluation information items. As another method of creating an analysis result, the analyzer 25b may determine a representative value according to information (environmental information, for example) that is included in retrieved evaluation information and is associated with evaluation information items.

### Variation of the Analysis Result Display Screen

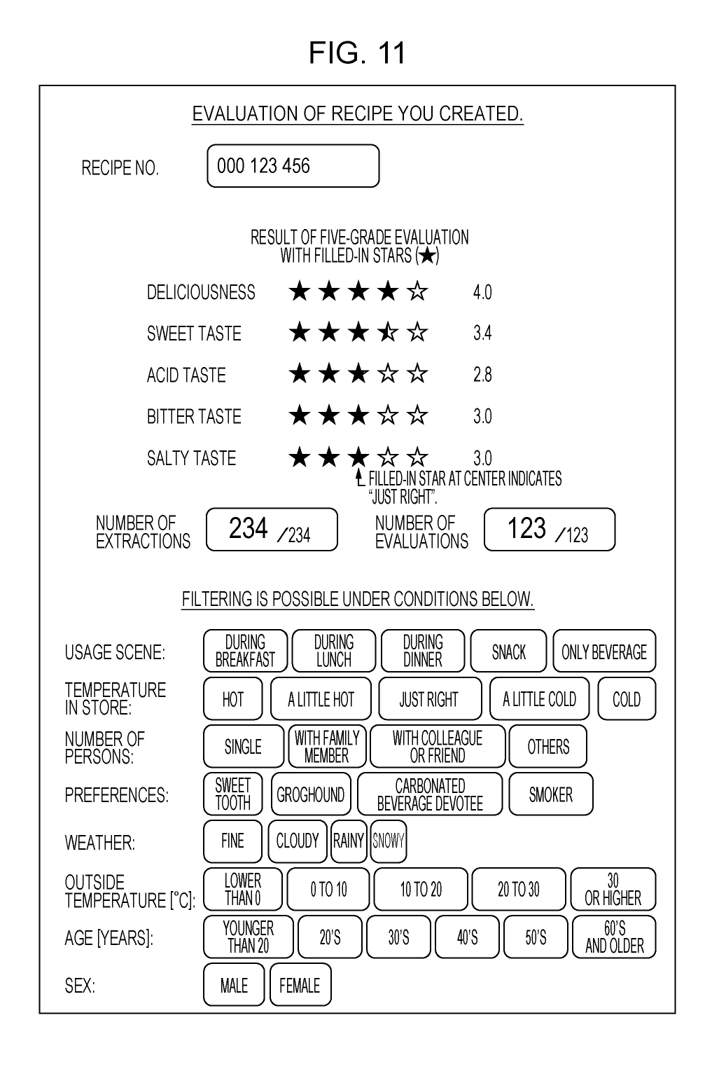

FIG. 11 illustrates an example of an analysis result display screen in the first variation of this embodiment. The display screen in FIG. 11 displays a recipe ID, an analysis result for evaluation information, the number of extractions, the number of evaluations, selection buttons for filtering conditions under which evaluation information is narrowed down, as in FIG. 6. The analysis result indicates statistical values for deliciousness, sweet taste, acid taste, bitter taste, and salty taste. The items in the situation information described above are added to the filtering conditions.

When the user presses any of the selection buttons for the filtering conditions, the filtering condition corresponding to the pressed selection button is transmitted from the smartphone 3 to the server 2. When the server 2 receives the filtering condition, the server 2 retrieves evaluation information satisfying the filtering condition from the evaluation information about the recipe ID for which analysis is in progress. The server 2 then analyses the retrieved evaluation information and creates an analysis result, after which the server 2 transmits the created analysis result to the smartphone 3 of the user. The controller 33 in the smartphone 3 receives the analysis result and causes the display device 31 to display the received analysis result.

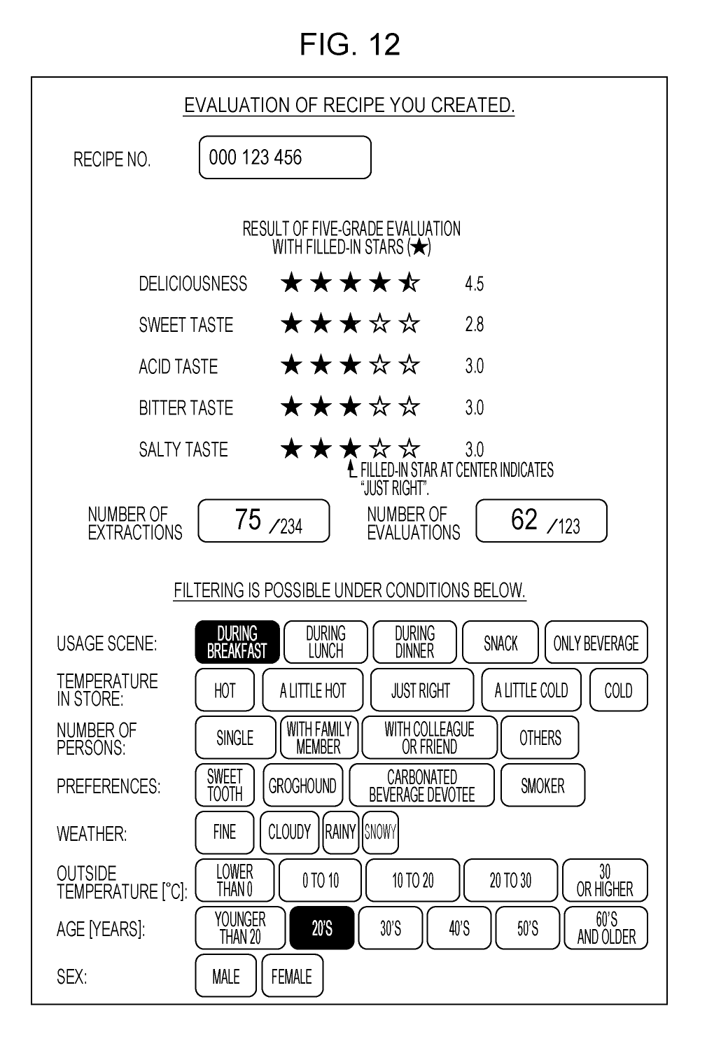

FIG. 12 illustrates a post-filtering analysis result display screen in the first variation of this embodiment. The display screen in FIG. 12 is an example in which the user has selected the filtering condition “during breakfast” for “usage scene” and the filtering condition “20s” for “age” on the display screen in FIG. 11.

As described above, when the user selects conditions, the user can obtain various analysis results. In the first variation of this embodiment, evaluation items are divided into more detailed items and items requiring entries of the usage environment equivalent to the situation information are added, as illustrated in FIG. 9. Therefore, a more detailed analysis result can be obtained.

In this embodiment and first variation described above, an example in which a user confirms an analysis result resulting from analyzing evaluations of a recipe has been described. However, a user who created a recipe may adjust the recipe according to its analysis result. An example in which a user who created a recipe adjusts the recipe will be described as a second variation.

### Second Variation of the Environment

After a user created a recipe, when the user performs, on the smartphone 3 owned by the user, a manipulation to adjust the recipe that the user created, the server 2 receives, from the smartphone 3, information about the manipulation, the information including the recipe ID of the recipe to be adjusted. The server 2 reads out recipe information from the one's own recipe DB 21 according to the recipe ID of the recipe to be adjusted, and transmits the read-out recipe information to the smartphone 3. The controller 33 in the smartphone 3 receives the recipe information and causes the display device 31 to display the recipe information.

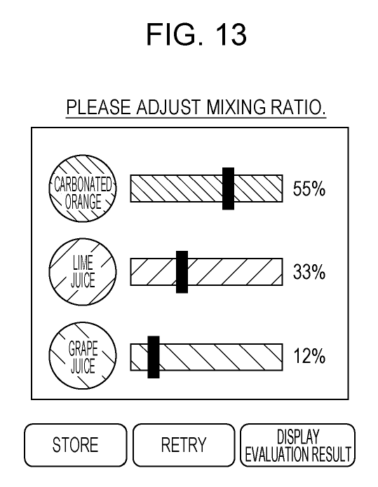

FIG. 13 illustrates an example of a display screen for recipe adjustment in a second variation of this embodiment. The display screen in FIG. 13 displays beverage raw materials in the recipe to be adjusted (in the example in FIG. 13, carbonated orange, lime juice, and grape juice) and their blending ratios. The display screen in FIG. 13 also displays the STORE button pressed to command the storage of an adjusted recipe, a RETRY button pressed to retry adjustment, and a DISPLAY EVALUATION RESULT button pressed to display an evaluation result for a similar recipe, the evaluation result being reference during adjustment.

When a user who performs adjustment presses the DISPLAY EVALUATION RESULT button while the user is adjusting a blending ratio in a recipe, the smartphone 3 transmits manipulation information including the blending ratio under adjustment to the server 2. The server 2 searches the one's own recipe DB 21 for another recipe including a blending ratio similar to the blending ratio under adjustment (this recipe will be referred to below as the similar recipe). The server 2 then analyzes evaluation information about the searched-for similar recipe and transmits information about the similar recipe, the information including an analysis result, to the smartphone 3. The controller 33 in the smartphone 3 receives the information about the similar recipe and causes the display device 31 to display the information.

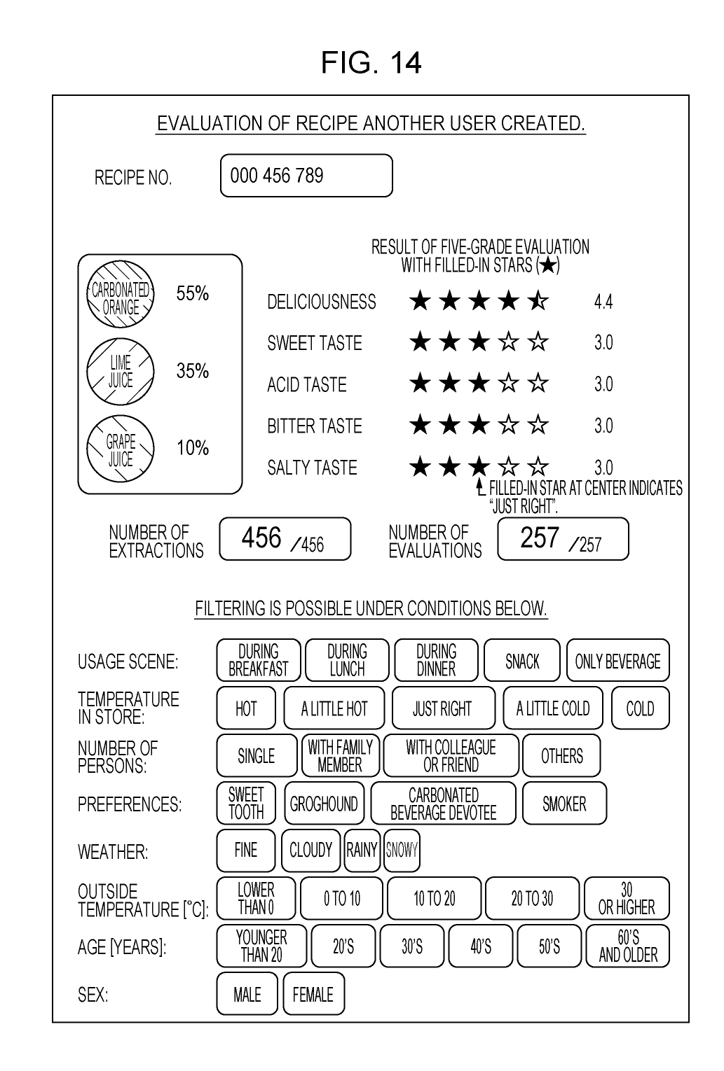

FIG. 14 illustrates an example of a similar recipe display screen in the second variation of this embodiment. The display screen in FIG. 14 displays the ID of a similar recipe, the contents of the similar recipe (beverage raw materials and their blending ratios), and analysis result for the similar recipe.

When the user who adjusts the recipe presses the DISPLAY EVALUATION RESULT button, the analysis result for the similar recipe as illustrated in FIG. 14 is displayed. The user adjusts the recipe with reference to the analysis result. Thus, a user who created a recipe can reference an analysis result for another recipe and can thereby adjust the recipe in more detail.

In the embodiment described above and its variations, examples in which beverage raw materials of cold beverages such as a carbonated orange beverage are blended have been mainly described. However, this is not a limitation on the present disclosure. The present disclosure is also applied to examples in which a plurality of raw materials eligible for blending are blended to create another blended material. For example, the present disclosure is applied to a case in which alcohol beverages such as a cocktail and a wine are blended and to a case in which a sauce and a dressing used in cooking are blended. Raw materials to be blended are not limited to liquids. The present disclosure is also applied to a case in which coffee beans, tea leaves such as boiled leaves and green tea leaves, and other solids, for example, are blended.

In the embodiment described above and its variations, a structure in which the dispenser 1 and server 2 are interconnected through the network N has been described. However, this is not a limitation on the present disclosure. The dispenser 1 and server 2 may be directly interconnected in a wired or wireless manner. In addition, the server 2 may be connected to another dispenser (not illustrated). If the server 2 is connected to a plurality of other dispensers, the server 2 may provide information to the plurality of other dispensers and may manage information received from the plurality of other dispensers.

The functions of the server 2 may be implemented by an application in a wireless terminal connected to the network N, such as the smartphone 3, or by software in a personal computer connected to the network N.

The dispenser 1 may have the functions of the server 2.

While the present disclosure has been described with respect to exemplary embodiments thereof, it will be apparent to those skilled in the art that the disclosure may be modified in numerous ways and may assume many embodiments other than those specifically described above. Accordingly, it is intended by the appended claims to cover all modifications of the disclosure that fall within the true spirit and scope of the disclosure.

The present disclosure encompasses a blending evaluation device described in the following items.

### [Item 1]

A blending evaluation device including:

a communication interface that receives evaluations of a blended beverage in which a plurality of beverage raw materials are blended, each of the evaluations being made by a user who drank the blended beverage;

a memory that stores the evaluations, each evaluation being associated with environmental information related to an environment in which the user drank the blended beverage; and

a controller that performs statistical analysis of information on the evaluations, wherein

the communication interface receives a condition that specifies the environmental information;

the controller retrieves, from the memory, at least one evaluation associated with the environmental information specified by the condition, and performs statistical analysis of the retrieved at least one evaluation, and

the communication interface transmits a result of the statistical analysis.

### [Item 2]

The blending evaluation device according to item 1, wherein:

each of the evaluations includes an evaluation value of the blended beverage; and

the controller outputs an average of evaluation values as the result of the statistical analysis.

### [Item 3]

The blending evaluation device according to item 1, wherein the environmental information includes at least one of a place in which the user drank the blended beverage, a time at which the user drank the blended beverage, and a psychological state when the user drank the blended beverage.

### [Item 4]

The blending evaluation device according to item 1, wherein the environmental information includes an attribute of the user.

### [Item 5]

The blending evaluation device according to item 1, wherein:

the controller analyzes an evaluation of a similar blended beverage, which has a blending ratio similar to a blending ratio of the blended beverage, and

the communication interface transmits a result obtained by analyzing the similar blended beverage to the second device.

### [Item 6]

The blending evaluation device according to item 1, wherein the communication interface receives situation information associated with an evaluation, the situation information being related to a situation in which the user drank the blended beverage and being input by the user.

So far, various embodiments have been described with reference to the drawings. However, it will be appreciated that the present disclosure is not limited to these embodiments. It is apparent that persons having ordinary skill in the art can devise various examples of variations and various examples of corrections, without departing from the intended scope of the claims of the present disclosure. It will be understood that these examples are of course included in the technical range of the present disclosure. Various constituent elements in the above embodiments may be arbitrarily combined, without departing from the intended scope of the present disclosure.

In the embodiments described above, the present disclosure has been described by taking a structure implemented by hardware as an example. However, the present disclosure can also be implemented by software that works in cooperation with hardware.

Functional blocks used to explain the above embodiment are typically implemented as large-scale integrated (LSI) circuits, each of which is a type of integrated circuit. Integrated circuits may control functional blocks used to explain the above embodiment and may have an input and an output. These integrated circuits may be individually implemented as a single chip or a single chip may be formed so as to include a part or all of the functional blocks. Although LSI circuits are referred to here, they may be referred to as integrated (IC) circuits, system LSI circuits, super LSI circuits, or ultra LSI circuits depending on the degree of integration.

Integrated circuits used to implement functional blocks are not limited to LSI circuits. A special circuits or a general-purpose processor may be used to implement functional blocks. Alternatively, a field programmable gate array (FPGA), in which programming is possible after an LSI circuit has been manufactured, or a reconfigurable processor, in which the connections and settings of circuit cells in an LSI circuit can be reconfigured, may be used.

Furthermore, if a technology of circuit integration appears as a substitution for LSI circuits due to advanced semiconductor technology or another technology derived from semiconductor technology, the technology may be of course used to integrate functional blocks. Application of bio-technology may be possible.

The present disclosure is useful for controlling a dispenser that provides beverages.

What is claimed is:

1. A blending evaluation device comprising:
a communication interface that receives evaluations of a blended beverage in which a plurality of beverage raw materials are blended, each of the evaluations being made by a user who drank the blended beverage;
a memory that stores the evaluations, each evaluation being associated with environmental information related to an environment in which the user drank the blended beverage; and
a controller that performs statistical analysis of information on the evaluations, wherein
the communication interface receives a condition that specifies the environmental information;
the controller retrieves, from the memory, at least one evaluation associated with the environmental information specified by the condition, and performs statistical analysis of the retrieved at least one evaluation, and
the communication interface transmits a result of the statistical analysis.

2. The blending evaluation device according to claim 1, wherein:
each of the evaluations includes an evaluation value of the blended beverage; and
the controller outputs an average of evaluation values as the result of the statistical analysis.

3. The blending evaluation device according to claim 1, wherein the environmental information includes at least one of a place in which the user drank the blended beverage, a time at which the user drank the blended beverage, and a psychological state when the user drank the blended beverage.

4. The blending evaluation device according to claim 1, wherein the environmental information includes an attribute of the user.

5. The blending evaluation device according to claim 1, wherein:
the controller analyzes an evaluation of a similar blended beverage, which has a blending ratio similar to a blending ratio of the blended beverage, and
the communication interface transmits a result obtained by analyzing the similar blended beverage to the second device.

6. The blending evaluation device according to claim 1, wherein the communication interface receives situation information associated with an evaluation, the situation information being related to a situation in which the user drank the blended beverage and being input by the user.
